(19) United States
(12) Patent Application Publication
(10) Pub. No.: US 2002/0022177 A1
(43) Pub. Date: Feb. 21, 2002

(54) Battery containing electrochemical cells, and process for its production

(75) Inventor: Klaus Hamm, Weinstadt (DE)

Correspondence Address: DARBY & DARBY P.C., 805 Third Avenue, New York, NY, 10022, US

(73) Assignee: HARRO HOFLIGER VERPACKUNGSMACHINEN GMBH, Allmersbach in Tal (DE)

(21) Appl. No.: 09/938,335

(22) Filed: Aug. 23, 2001

Related U.S. Application Data
(63) Continuation of application No. PCT/DE00/00709, filed on Mar. 9, 2000.

(30) Foreign Application Priority Data
Mar. 10, 1999 (DE) 199 10 433.6

(51) Int. Cl. H01M 6/46; H01M 10/00

(52) U.S. Cl. 429/127; 29/623.1; 429/162

(57) ABSTRACT

A process for producing a battery (10) containing electrochemical cells is distinguished by the fact that an electrically non-conductive track (30) or a similar coating is applied to the respective free edge region (26) of the two housing parts (12.1, 12. 2) between which the anode and cathode lugs (18) are guided out of the battery housing (12), in such away that it (30) is present at least in the regions of the lugs (18), and that it project beyond the free edge (20) of the housing part (12.1, 12.2) to which it is attached and/or engages around this free edge.

### TECHNICAL FIELD

The invention relates to a battery containing electro-chemical cells and to its production.

The electrochemical cells of the battery, which are exposed to electrolyte, have cathodes and anodes. The addition of this electrolyte causes the electrochemical cells to be activated, i.e. made ready to operate.

Flat batteries, such as for example Li-Ion batteries, are welded into composite aluminium foils. On the inner side, the composite foils have a coating which joins them to the terminals of the battery plates, thus allowing gastight packing.

### PRIOR ART

It is known to use thermoforming machines for the production of batteries which contain electrochemical cells. On these machines, the relatively rigid composite foil is either thermoformed on one side and provided with a covering film, or both composite foils are provided with a recess, in each case by thermoforming, and are then folded together and welded to one another. In this case, the battery plates are situated in the two opposite recesses. The cathode and anode lugs, which form the electrical terminals of the battery, are led, as flat metal foils, out of one side of the container, between the two container parts which are each provided with a hollow. The anode and cathode lugs must not under any circumstances come into contact with the cut edges of the composite aluminium foil, since otherwise a short circuit would be produced and the battery would be destroyed. For this reason, the edge strips of the composite foil , in the region of which the anode and cathode lugs are located, are folded over outwards through about 90° even before the two housing parts are brought together. After the battery housing has been produced, the edge strips are once again folded over through 90°, i.e. through a total of 180°. On account of the rigidity of the composite foil, this folding technique constitutes a considerable outlay.

### OUTLINE OF THE INVENTION

Working on the basis of this known prior art, the invention is based on the object of providing a possibility which is as economical as possible for producing batteries which contain electrochemical cells.

A process according to the invention for producing such batteries is given by the features of claim 1. The inventive battery itself is the subject matter of the independent claim 11. Refinements of both the process according to the invention and the batteries according to the invention form the subject matter of following subclaims.

A first significant advantage of the invention consists in the fact that the edge strips of the battery housing, i.e. for example the edge strips of the Al composite foils used, no longer have to be folded over in a complex way in order to prevent electrical contact with the anode and cathode lugs, but rather an electrically non-conductive barrier is positioned between the electrically conductive end sides of the mutually opposite edge strips of the two composite foils and the electrically conductive lugs. This barrier may be designed and provided in the form of a track or a coating. The track or coating may be applied to the respective inner side of the two composite foils, for example by welding. The track can then project beyond or overlap the end side of the two composite foils. The coating can be joined to the anode and cathode lugs and in this way insulate them from the composite foil.

A very significant refinement of the invention is based on the recognition that batteries of this type can be produced on flat-bag machines instead of on thermoforming machines. Flat-bag machines not only have a high capacity but also overall represent a possible means of producing “housings” in what in relative terms is a very economical manner. Each housing is then in the form of a bag. However, the folding technique which is used in the prior art in thermoforming machines for the upper edge strips of the composite foil cannot be used when flat-bag machines are being employed. Only the abovementioned possibility of preventing electrical contact between the end sides of the composite foils and the anode and cathode lugs by means of inserted electrically non-conductive material allows flat-bag machines, which operate favourably in economic terms, to be used.

On the flat-bag machine, the individual bags can be produced from a composite foil web which is pulled off an endless reel. As is known per se, the composite foil web which is pulled off the reel can be folded once in the direction in which it is pulled off. The lower longitudinal fold then forms the base region of the bag which is subsequently formed. The two opposite V-shaped web parts, which form what will later be the two bag walls, are joined together by transverse sealing seams which are spaced apart from one another. The bags which are open at the top are then formed between in each case two transverse sealing seams. The bags which are open at the top are then produced between in each case two transverse sealing seams. Then, as is known per se with flat-bag machines, the appropriate filling material can be introduced into the bag which is open at the top. In the present case, this filling material comprises electrochemical cells and electrolyte. After the filling operation has finished, each bag is closed off by means of an upper sealing seam.

Before the upper sealing seam is applied, and therefore before the individual bags are closed off, the above-mentioned, electrically non-conductive tracks can be applied to the inner sides of the upper two edge strips of the two bag walls. Two corresponding tracks can be applied to the longitudinal edges of the composite foil even before the longitudinal folding of the composite foil web. However, it is also possible for these tracks to be applied, in particular welded, to the bag walls subsequently, for example after the longitudinal fold has been applied. A possibility of this type has proven particularly expedient when using a reclosable strip which is known per se. A reclosable strip of this type comprises two parts which can be attached to one another by being hooked together. A corresponding technique for applying a reclosable strip to the battery bag walls forms the subject matter of an exemplary embodiment which is illustrated in the drawing.

The use of the two halves of a reclosable strip as electrically non-conductive webs has the advantage that the two halves of the reclosable strip can be welded to the bag walls in such a manner that they are precisely matched to one another in terms of height. This is because the welding can take place in the closed state of the reclosable strip. Consequently, it is impossible for the electrically non-conductive webs on the composite foil walls to be offset in terms of height or to slip. In this way, on the one hand the respective end sides of the two composite foils are prevented from coming into contact with the anode and cathode lugs, and on the other hand one or the other of the electrically non-conductive web strips is prevented from being able to reach the region of the upper longitudinal sealing seam. This is because, for sealing reasons, the electrically non-conductive web should be present above the longitudinal sealing seam. Therefore, the reclosable strip is not used in the finished flat bag for reasons of its closure technique, but rather, on account of its closure technique, it is only used for precise introduction into the region between the two bag walls. An additional but not imperative aspect is that the thickening of the reclosable strip which is present in the region of its closure region further increases contact protection in the region of the anode and cathode lugs.

When using a web in the form of an insulating strip which, on account of its composition or its coating, is joined to the anode and cathode lugs, the subsequent longitudinal sealing seam could also be provided in the region of the insulating strip.

The introduction of a reclosable strip into the region between the two bag walls can take place using a holder, in which the reclosable strip is guided in its closed state. This holder can be positioned in the V-shaped space between the two bag walls in a similar way to a sword. Then, the bag walls can be welded to the outer sides of the reclosable strip without problems by means of external sealing jaws, and as a result the two halves of the reclosable strip, which are still joined together, can be securely welded to the inner sides of the two bag walls. The fact that the two halves of the reclosable strip are clamped together by the closing technique of the reclosable strip means that they are at the same, precisely predetermined height relative to the edge of the bag walls and are then attached to the bag walls at this height. By pulling open the reclosable strip, the bag walls can be removed from one another and in this way the bag can be opened. Then, the electrochemical cells and the electrolyte can be introduced into the bag. On account of the exact positioning of the reclosable strip on the bag walls, the upper longitudinal sealing seam, which closes the bag, can be arranged reliably and without problems.

It is not necessarily the case that all its material regions are required by the reclosable strip. In the exemplary embodiment illustrated in the drawing, only its “lower” region, including its closure region, is present. The closure region may also form its upper end. In this case, the upper end of the reclosable strip may project upward out of the region of the bag walls. The thickened, open closure region of the reclosable strip spreads the two edge regions of the bag walls apart from one another, which prevents contact and therefore the formation of a short circuit between the two lugs through contact with the metallic free ends of the bag walls.

Further configurations and advantages of the invention, in particular also with regard to cap solutions which replace the reclosable strip, can be found from the features which are listed further in the claims and from the exemplary embodiment below.

### BRIEF DESCRIPTION OF THE DRAWING In the drawing:

FIG. 1 shows a diagrammatic side view of a battery according to the invention which contains electrochemical cells,

FIG. 2 shows a section on line 2-2 in FIG. 1,

FIG. 3 shows an enlarged illustration of part of the upper region of the battery shown in FIG. 1,

FIG. 4 shows a further enlarged partial cross section through the upper edge region of the battery shown in FIG. 1,

FIG. 5 shows a diagrammatic side view of the illustration shown in FIG. 4, without the outer welding jaws being illustrated,

FIG. 6 shows a diagrammatic side view of the upper region of a battery according to a further embodiment of the invention,

FIG. 7 shows a diagrammatic side view of the upper region of a bag in an intermediate state of its production, according to a further modified embodiment of the invention.

### WAYS OF EMBODYING THE INVENTION

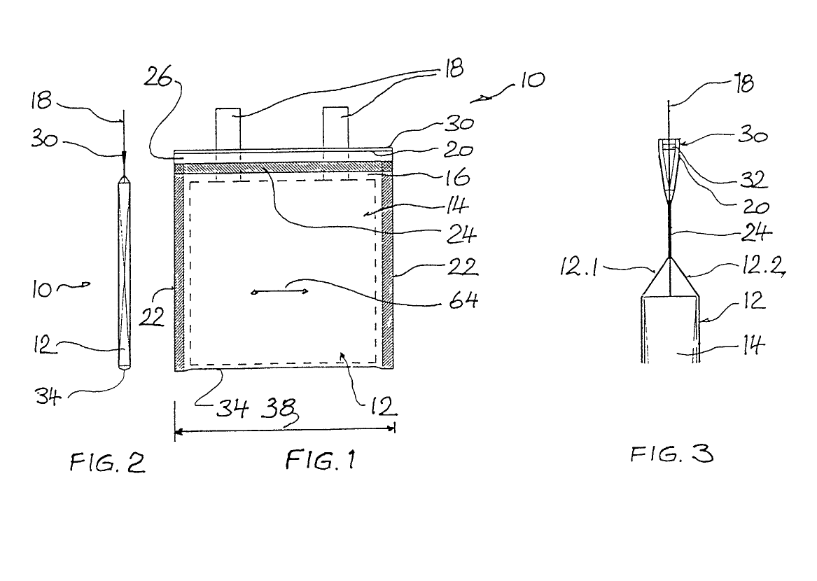

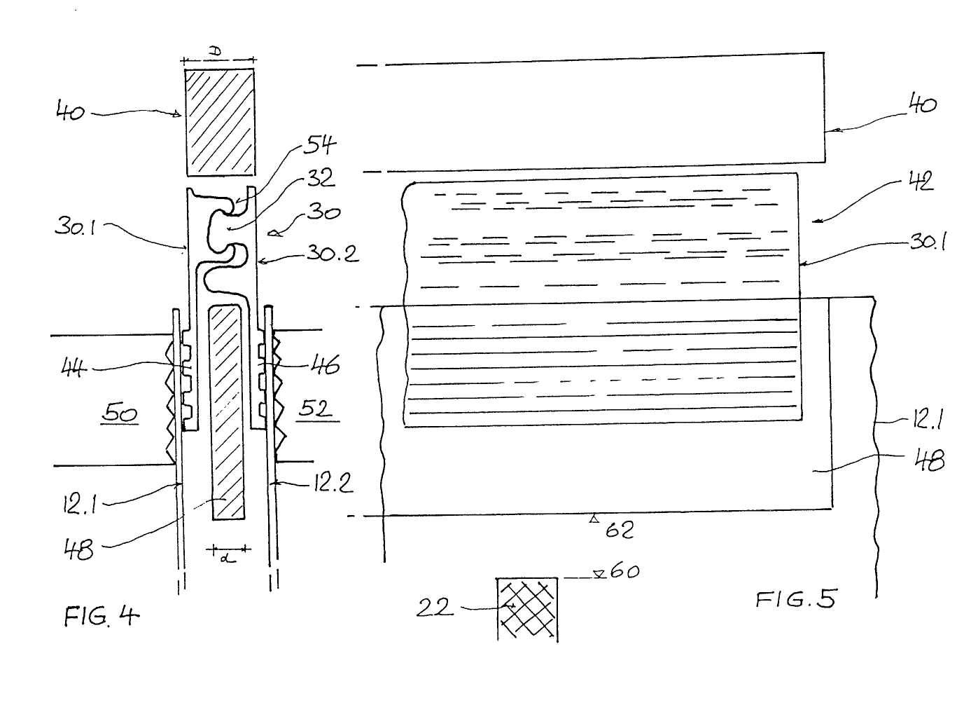

FIG. 1 shows a battery 10 which contains electro-chemical cells. The housing of this battery 10 comprises a so-called flat bag 12. The battery plates 14 and electrolyte 16 are mounted inside this flat bag 12. The terminal lugs 18 comprising anode and cathode lugs project out of the top of the flat bag 12. The top edge of the flat bag 12, i.e. its upper free edge 20, has a reclosable strip 30 projecting above it, as seen in the drawing. As is customary with flat bags, the flat bag 12 has lateral transverse sealing seams 22 and an upper longitudinal sealing seam 24 which closes off the bag 12. The production of flat bags 12 of this type on a flat-bag machine with transverse sealing seams 22 and longitudinal sealing seams 24, and their filling with, for example, food stuffs, is known per se.

In the present case, the upper longitudinal sealing seam 24 is arranged so as to leave clear an edge region 26, and therefore at a certain distance from the bag edge 20. To this extent, this flat bag 12 differs from conventionally produced flat bags. In this edge region 26, the reclosable strip (RCS) 30 is arranged in such a way that it is attached, or welded as in the present case, to the respective inner sides of the mutually opposite bag walls 12.1. and 12.2 (FIG. 3) by means of its outer sides.

The reclosable strip 30 is a known object and consists of an electrically non-conductive plastic material. The material of the flat bag 12 consists of an aluminium composite foil. The cut edges of the composite foil form the upper free bag edge 20 and are freely accessible from the outside. These cut edges of the two bag walls 12.1 and 12.2 form the electrically conductive locations of the two bag walls in the region of their upper edge regions and therefore must not come into contact with the terminal lugs 18 projecting between them, in order to avoid a short circuit which would destroy the battery.

In the present case, the left-hand and right-hand parts, respectively, of a reclosable strip 30 are present on both sides of the terminal lugs 18, between the terminal lugs 18 and the two bag walls 12.1 and 12.2, in the region of the respective bag edge 20. The thickened part 32 of the reclosable strip 30, in the region of its clamping region, causes the bag edges 20 in each case to be pushed away outwards from the connection lugs 18. The resulting spreading of the bag edge 20 increases the protection against contact between the terminal lugs 18 and bag edge 20.

As shown in FIG. 4, the upper attachment limbs of the reclosable strip 30 have been almost completely removed, since they are not required. Therefore, the reclosable strip 30 substantially only has its lower attachment strips 30.1 and 30.2, by means of which it is welded to the two bag walls 12.1 and 12.2.

The production of the battery 10 in combination with the flat bag 12 takes place in the following way.

The production of a flat bag 12 or of a bottom-fold bag is known per se. In the present case, the bag comprises a single-part composite foil web. During its production, this single-part composite foil web is folded about an edge which runs in the pull-off direction of the web. The result is the lower longitudinal fold 34. In the transverse direction of the web, the two walls 12.1 and 12.2 form two halves of the web and are joined integrally to one another via the longitudinal fold 34.

The bottom region of the bag 12 may be of different design depending on what type of bag is involved. Irrespective of the particular design of the bottom, the lower region of a reclosable strip 30 is arranged in the upper region of the bag in the region of its opening.

When the battery 10 is being produced, the composite foil web passes through at least two downstream sealing stations. In a first sealing station, transverse sealing seams 22 are applied, and in a further sealing station the longitudinal sealing seam 24 is applied, and in this way the opposite bag walls 12.1 and 12.2 are joined together at the said locations. The transverse sealing seams 22 may also be provided initially in a lower region and then subsequently in a second, upper region, in order to allow undisturbed welding-on of the reclosable strip 30 over the entire length 38 of the bag 12. The reclosable strip 30 or its lower parts can then easily be placed in the correct position, for example by means of a sword-like holding plate 40 between the upper regions of the two bag walls 12.1. and 12.2.

To apply the reclosable strip 30 to the two bag walls 12.1. and 12.2, this strip is, for example, enclosed in a longitudinal slot 42 in the holding plate 40. Above the longitudinal slot 42, the holding plate 40 has a thickness D. Below the longitudinal slot 42, the web 48 of the holding plate 40 which is present at that location has a thickness D which is less than the thickness D at least by the thickness of the two limbs 44, 46 of the two halves 30.1 and 30.2 of the reclosable strip 30. In the region adjoining the longitudinal slot 42, which is not illustrated in the drawing, the holding plate 40 is of tunnel-like design. As a result, the continuous reclosable strip 30 can be pulled longitudinally through the tunnel until, on emerging from the tunnel, it is present in the longitudinal slot 42, with its outer side approximately flush with the outer side of the holding plate 40.

By means of outer left-hand and right-hand sealing jaws 50, 52 which are known per se in the prior art, the continuous reclosable strip 30 can be welded by means of its two lower limbs 44, 46 to the two bag walls 12.1 and 12.2 in the region of their upper edge regions 26. Since the sealing jaws are not arranged in the region of the mutual clamping region 54 of the two halves 30.1, 30.2 of the reclosable strip 30, the heat which is released by the sealing jaws is not introduced directly into this clamping region 54, but rather only into the region of the limbs 44, 46 and of the bag walls 12.1 and 12.2 which are present in this region. While the limbs 44, 46 of the reclosable strip 30 are being welded to the bag walls 12.1 and 12.2, the clamping region 54 is not thermally deformed. Consequently, it is possible for the reclosable strip 30 to be opened up again as a result of its two halves 30.1 and 30.2 being pulled apart again from their clamped-together arrangement.

To ensure that the presence of the holding plate 40 between the bag walls 12.1 and 12.2 does not interfere with the application of the transverse sealing seams 22, since the holding plate 40 covers the region of a plurality of transverse sealing seams, the transverse sealing seams may initially be provided in a lower region and, after the reclosable strip 30 has been welded on and the holding plate 40 is then not present, can also be provided in their upper region. If there is a sufficient vertical distance between the upper edge 60 of the transverse sealing seams 22 and the lower edge 62 of the holding plate 40, the transverse sealing seams 22 may also be provided as a single piece.

After the reclosable strip 30 has been attached to the bag walls 12.1 and 12.2, the reclosable strip 30 is pulled apart, and in this way the bag 12 is opened. It is now possible for the battery plate 14 and the electrolyte 16 to be introduced into the corresponding bag 12.

The two halves of the reclosable strip 30 or the other comparatively electrically insulating materials which are present may also be joined unreleasably to one another, if they are then cut open in the longitudinal direction 64 or are cut off approx. 1-2 mm above the free edge 20 of the bag walls 12.1 and 12.2.

After the bag 12 has been filled, it is closed by the application of the upper longitudinal sealing seam 24. In the present case, the upper edge 60 of the transverse sealing seam 22 is simultaneously also the upper edge of the longitudinal sealing seam 24. In this way, an optimally sealed bag corner is also formed in the region where transverse sealing seam 22 and longitudinal sealing seam 24 abut one another.

Instead of the reclosable strip 30, it would also be possible for a different electrically non-conductive foil or a similar accumulation of material to be provided in the upper region of the bag wall 12.1, 12.2. The use of the reclosable strip 30 has the advantage that its two halves 30.1, 30.2 can be guided off a reel between the composite foil which has been spread apart in a V-shape using a common device. Not only the guidance of the two halves but also the precise vertical orientation of the two halves 30.1, 30.2 with respect to one another are ensured, since they can be supplied with the two halves 30.1, 30.2 clamped together. The supply via the holding plate 40 ensures that the two halves, in terms of height, can be precisely positioned not only at the same height as one another but also with respect to the bag walls, and can then be welded.

An additional advantage of the reclosable strip which has emerged is its strengthened clamping region. The inevitable spreading of the two upper bag edges 20 that this causes increases the protection against contact between the terminal lugs 18 and the bag edge 20.

The use of a flat-bag machine makes it possible to keep the bag upright while it is being filled and closed. By contrast, the known batteries are filled and closed when lying flat. The latter operation imposes considerably higher demands on the manufacturing process than, by contrast, when the bags are oriented in a hanging or upright position.

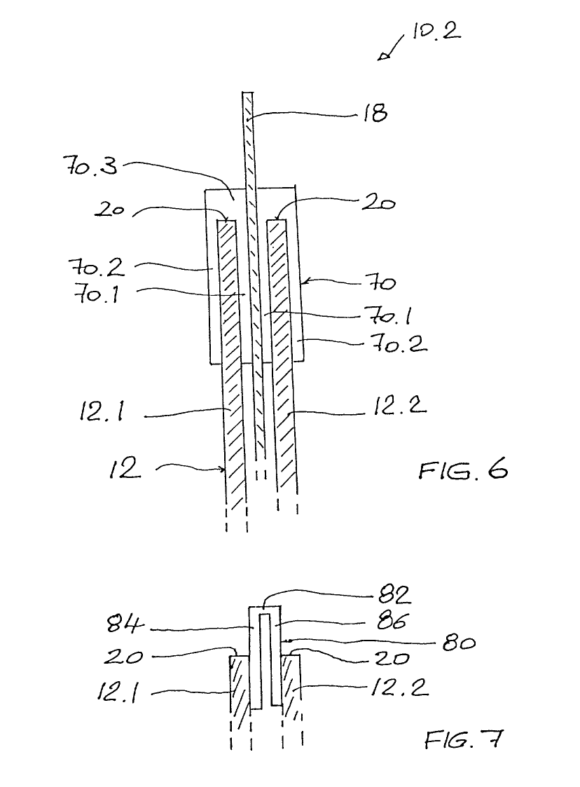

In the case of the battery 10.2 illustrated in FIG. 6, there is a flat bag 12, the bag walls 12.1, 12.2 of which are covered by an upper cap 70. Like the reclosable strip 30, this cap 70 consists of an electrically non-conductive material. The inner material strip 70.1 of this cap 70 bears against the inner side of the respective bag wall 12.1 or 12.2, and its outer material strip 70.2 bears from the outside against the respective bag wall 12.1 or 12.2. The outer materials strips 70.2 are shorter than the inner material strips 70.1. Consequently, sealing jaws which are required in order to weld the inner material strips 70.2 onto the bag walls 12.1, 12.2 can be applied to the two bag walls 12.1, 12.2 directly from the outside. By means of its covering material strips 70.3, each cap 70 covers the upper bag edge 20 of the respective bag wall 12.1 or 12.2. The lugs 18 which project upwards out of the flat bag 12 between the two caps 70 are as a result separated in an insulating manner from the upper edge 20 of the two bag walls 12.1, 12.2. It is also possible for the lugs 18 to be bent over through 90° or 180° without problems.

If the material of the cap 70 is joined to the lugs 18 in such a way that the lugs 18 are enclosed in a gastight manner by the cap 70, the upper longitudinal sealing seam 24 can also be provided in the region of the two caps 70. The outer material strips 70.2 would then be joined in a gastight manner to the bag wall 12.1 or 12.2. In the region of the lugs 18, the inner material strips 70.1 would be laid in a gastight manner around the lugs 18 or would be joined in a gastight manner to the lugs 18. Where there are no lugs 18, the two inner material strips 70.1 of the two caps 70 would be joined together in a gastight manner. In this way, a bag 12 could be closed in a gastight manner in the region of the caps 70.

In the intermediate stage of the battery which is to be produced, as illustrated in FIG. 7, the two bag walls 12.1, 12.2 are for the time being closed off by means of a single cap 80.

For this purpose, the two limbs 84, 86 of the U-shaped cap 80 have been welded to the inner sides of the two bag walls 12.1, 12.2. In order for the bag to be filled, the web 82 is separated from the cap, so that there is then an opening for filling the bag.

In the above embodiments which are portrayed by way of example, additional layers of material are present on the bag walls. These layers of material may, for example, be parts of a reclosable strip 30 or of a cap 70, 80. The layers of material may also be formed by coating of the bag walls 12.1, 12.2. Furthermore, it would be possible for an insulating layer to be provided only in the region of the upper bag edge 20 of each bag wall 12.1, 12.2. The cap 70, which is illustrated by way of example in FIG. 6, would then more or less be present only with one covering material strip 70.3. It remains important in all embodiments that an electrically non-conductive, insulating material is positioned between the electrically conductive upper bag edge 20 and the electric lugs 18.

1. Process for producing a battery (10) containing electrochemical cells,
having a housing (12) which comprises two housing parts (12.1, 12.2) in which the cells, which are impregnated with electrolyte, are enclosed in a gastight manner, projecting between the two housing parts by means of their anode and cathode lugs (18),
having electrically non-conductive material (30, 70) between the lugs (18) and the electrically conductive locations of the housing parts (12.1, 12.2) at which the lugs (18) lead out of the housing (12), characterized in that,
the housing is produced as a flat bag (12) on a flat-bag machine, is filled with the electrochemical cells and the electrolyte, and is then closed by means of an upper longitudinal sealing seam (24).

2. Process according to claim 1, characterized in that
the material is applied as a coating to the two housing parts (12.1, 12.2).

3. Process according to claim 1, characterized in that
the material is designed in the form of a cap (70) on each of the two housing parts (12.1, 12.2).

4. Process according to claim 1, characterized in that
the material is applied to the two housing parts (12.1, 12.2) in the form of a U-shaped cap (80), in that
the two limbs (84, 86) of the cap (80) bear against the two edge regions (26) of the two housing parts (12.1, 12.2),
and then, at least in the region of the lugs (18) of the battery (10) which is subsequently to be mounted in the housing (12), an aperture is produced in the web (82) of the cap (80) for these lugs (18).

5. Process according to claim 4, characterized in that
the web (82) of the cap (80) is separated from the limbs (84, 86).

6. Process according to claim 1, characterized in that
an electrically non-conductive track (30) is arranged on each of the two edge regions (26) of the two housing parts (12. 1, 12.2) between which the lugs (18) are guided out of the housing (12), in such a way
that this track (30) is present at least in the regions of the lugs (18), and
that it projects beyond the free edge (20) of the housing part (12.1, 12.2) against which it bears, and/or engages around this free edge.

7. Process according to claim 6, characterized in that
a reclosable strip (30) or a part thereof is used as electrically non-conductive track s.

8. Process according to claim 1, characterized in that
the upper longitudinal sealing seam (24) is arranged beneath exposed edge regions (26) of the two bag walls (12.1, 12.2),
in the region of these exposed edge regions (26) electrically non-conductive material (30) is applied to each inner side of the two bag walls (12.1, 12.2), in such a way that the material projects beyond the free upper edge (20) of the bag wall (12.1, 12.2) against which it bears on the inside and/or engages around this edge.

9. Process according to claim 1, characterized in that
this upper longitudinal sealing seam (24) is arranged in the region of the upper edge region (26) of the two bag walls (12.1, 12.2),
electrically non-conductive material (30) is applied to each inner side of the two bag walls (12.1, 12.2) in the region of these edge regions (26), in such a way that the material (30) projects beyond the free upper edge (20) of the bag wall (12.1, 12.2) against which it bears on the inside and/or engages around this edge.

10. process according to claim 8, characterized in that
a continuous reclosable strip (RCS) (30), at least the closure region (32) of which is present, or the cap (80) is introduced into a holder (40) and, together with the holder (40), is positioned between the upper edge strips (26) of the folded bag track (12) in such a way that the two outer sides of the RCS (30) or of the cap (80) bear against the two opposite inner sides of the two bag walls (12.1, 12.2) of the bag track,
the continuous RCS (30) or the limbs (82, 86) of the cap (80) are in each case welded onto the two bag walls (12.1, 12.2),
the RCS (30) or the cap (80), after the removal of its web (82), is then pulled apart, and as a result the bag (12) is opened up in order to be filled.

11. The process as claimed in claim 1, characterized in that
first of all the two electrically non-conductive tracks (30) or the coating and then the transverse sealing seams (22) which separate the bags (12) from one another are applied.

12. Battery (10) containing electrochemical cells, in which the cells which are exposed to electrolyte are enclosed in a gastight manner in a housing (12) comprising two housing parts (12.1, 12.2), and project, by means of their anode and cathode lugs (18), between the two housing parts, according to one of the preceding claims, characterized in that
the housing is a flat bag (12) produced on a flat-bag machine,
an electrically non-conductive material (30) is arranged in each case at least in the upper regions (26) of the two bag walls (12.1, 12.2) between which the lugs (18) lead out of the bag (12), in such a way that the material (30) separates the lugs (18) from the electrically conductive locations of the bag walls (12.1, 12.2) in an electrically insulating manner.

13. Battery (10) according to claim 12, characterized in that
the two upper free bag edges (20) are the electrically conductive locations of the bag walls (12.1, 12.2).

14. Battery (10) according to claim 12, characterized in that
the housing is a flat bag (12),
an electrically non-conductive coating is present as material.

15. Battery (10) according to claim 12, characterized in that
the material rests in the form in a cap (70) on each of the two housing parts (12.1, 12.2).

16. Battery according to claim 12, characterized in that
the material is present in the form of in each case one track (30) at least in the regions of the lugs (18), in such a way
that the respective track (30) projects beyond the free edge (20) of the corresponding bag wall (12.1, 12.2) and/or engages around the free edge (20) of the edge region (20) to which it is attached.

17. Battery (10) according to claim 12, characterized in that
the flat bag (12) is produced from a composite foil.

18. Battery (10) according to claim 16, characterized in that,
the two electrically non-conductive tracks are a reclosable strip (RCS) (30), a part of a reclosable strip (30) of this type or the two limbs (84, 86) of a U-shaped cap (80).
